(19) United States
(12) Patent Application Publication
(10) Pub. No.: US 2024/0015273 A1
(43) Pub. Date: Jan. 11, 2024

(54) PROJECTION DEVICE

(71) Applicant: Coretronic Corporation, Hsin-Chu (TW)

(72) Inventors: Chang-Hsuan Chen, Hsin-Chu (TW); Ming-Tsung Weng, Hsin-Chu (TW)

(73) Assignee: Coretronic Corporation, Hsin-Chu (TW)

(21) Appl. No.: 18/342,682

(22) Filed: Jun. 27, 2023

(30) Foreign Application Priority Data
Jul. 5, 2022 (CN) 202210789981.7

(51) Int. Cl. H04N 9/31; G03B 21/14; G03B 21/20

(52) U.S. Cl. CPC H04N 9/3197; H04N 9/3164; H04N 9/317; G03B 21/142; G03B 21/2053; H04N 9/3108

(57) ABSTRACT

A projection device including an illumination system, a light valve, and a projection lens is provided. The illumination system emits an illumination light beam. The illumination system includes at least one light-emitting device, and the at least one light-emitting device includes multiple light-emitting assemblies. The light valve is disposed on a transmission path of the illumination light beam and converts the illumination light beam into an image light beam. The light valve includes multiple light modulation regions. The projection lens is disposed on a transmission path of the image light beam, and is configured to project the image light beam out of the projection device. The illumination light beams emitted by the light-emitting assemblies of the at least one light-emitting device form multiple light spots on the light valve, and the light modulation regions are respectively covered by the light spots.

### CROSS-REFERENCE TO RELATED APPLICATION

This application claims the priority benefit of Chinese application no. 202210789981.7, filed on Jul. 5, 2022. The entirety of the above-mentioned patent application is hereby incorporated by reference herein and made a part of this specification.

### BACKGROUND

### Technical Field

The invention relates to an optical device, and particularly relates to a projection device.

### Description of Related Art

In a current projection device, an illumination light beam is first uniformed by a light uniforming element, then the uniformed illumination light beam is converted into an image light beam by a light valve, and finally the image light beam is projected on a screen or a wall by a projection lens. However, the uniformed image light beam reduces a contrast between a dark region and a bright region of a projected image. Therefore, the imaging quality of the projection device is relatively adversely affected.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The invention is directed to a projection device, which is adapted to perform local dimming for a light valve, so that the projection device has a high contrast ratio.

Other objects and advantages of the invention may be further illustrated by the technical features broadly embodied and described as follows.

In order to achieve one or a portion of or all of the objects or other objects, an embodiment of the invention provides a projection device including an illumination system, a light valve and a projection lens. The illumination system is configured to emit an illumination light beam. The illumination system includes at least one light-emitting device, and the at least one light-emitting device includes a plurality of light-emitting assemblies. The light valve is disposed on a transmission path of the illumination light beam and is configured to convert the illumination light beam into an image light beam. The light valve includes a plurality of light modulation regions. The projection lens is disposed on a transmission path of the image light beam, and is configured to project the image light beam out of the projection device. The plurality of light-emitting assemblies of the at least one light-emitting device emit the illumination light beams, and the illumination light beams form a plurality of light spots on the light valve, and the plurality of light modulation regions are respectively covered by the plurality of light spots.

In an embodiment, the plurality of light-emitting assemblies include a first light-emitting assembly, a second light-emitting assembly, and a third light-emitting assembly, where the first light-emitting assembly and the second light-emitting assembly are adjacent in a first direction, the first light-emitting assembly and the third light-emitting assembly are adjacent in a second direction, the first direction is not parallel to the second direction, and the plurality of light modulation regions include a first light modulation region, a second light modulation region, and a third light modulation region, where the first light modulation region and the second light modulation region are adjacent in a third direction, the first light modulation region and the third light modulation region are adjacent in a fourth direction, and the third direction is not parallel to the fourth direction.

In an embodiment, the first direction is perpendicular to the second direction.

In an embodiment, the third direction is perpendicular to the fourth direction.

In an embodiment, the plurality of light spots include a first light spot, a second light spot, and a third light spot. The illumination light beams emitted by the first light-emitting assembly, the second light-emitting assembly, and the third light-emitting assembly respectively form the first light spot, the second light spot, and the third light spot on the light valve. The first light modulation region, the second light modulation region, and the third light modulation region are respectively covered by the first light spot, the second light spot, and the third light spot.

In an embodiment, the first light spot and the second light spot are at least partially non-overlapped, and the first light spot and the third light spot are at least partially non-overlapped.

In an embodiment, a number of the at least one light-emitting device is multiple, and the light-emitting devices include a first light-emitting device, a second light-emitting device, and a third light-emitting device respectively configured to emit a first color light beam, a second color light beam, and a third color light beam.

In an embodiment, the illumination system further includes a light guide element configured to guide the first color light beam, the second color light beam, and the third color light beam to the light valve.

In an embodiment, each of the first light-emitting device, the second light-emitting device, and the third light-emitting device includes the plurality of light-emitting assemblies illuminating the plurality of light modulation regions.

In an embodiment, each of the plurality of light-emitting assemblies includes a plurality of color light-emitting elements, and the plurality of color light-emitting elements are configured to emit a plurality of color light beams.

In an embodiment, the illumination system further includes a local dimming element, which is electrically connected to each of the plurality of light-emitting assemblies and configured to control a light-emitting intensity of each of the light-emitting assemblies.

In an embodiment, the projection device further includes a light diffusing element, which is disposed on the transmission path of the illumination light beam and is located between the illumination system and the light valve, where after the illumination light beams emitted by the plurality of light-emitting assemblies pass through the light diffusing element, the illumination light beams form the plurality of light spots on the light valve, the plurality of light modulation regions are respectively covered by the plurality of light spots, and the plurality of light spots are at least partially overlapped with each other.

In an embodiment, the projection device further includes at least one of a depolarizer and a despeckling element, which is disposed on the transmission path of the illumination light beam and located between the light diffusing element and the light valve.

In an embodiment, the projection device further includes at least one lens element, which is disposed on the transmission path of the illumination light beam and is located between the illumination system and the light valve.

In an embodiment, the projection device further includes at least one actuating element, the at least one lens is disposed on the at least one actuating element, the at least one actuating element is configured to move a position of the at least one lens element or change an inclination angle of the at least one lens element relative to the at least one light-emitting device, and positions and sizes of the plurality of light spots relative to the plurality of light modulation regions change along with the inclination angle of the at least one lens element and movement of the at least one lens element.

Based on the above description, the projection device provided by the embodiment of the invention respectively illuminates the plurality of light modulation regions of the light valve with a plurality of illumination light beams emitted by a plurality of light-emitting assemblies. The plurality of light-emitting assemblies may respectively control optical performances of the plurality of light spots on the plurality of light modulation regions, thus achieving the purpose of local dimming for the light valve, thereby improving a contrast ratio of the image projected by the projection device.

To make the aforementioned more comprehensible, several embodiments accompanied with drawings are described in detail as follows.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic diagram of a projection device according to an embodiment of the invention.

FIG. 1B is a schematic diagram of a light-emitting device of the projection device shown in FIG. 1A.

FIG. 1C is a schematic plan view of a light valve of the projection device shown in FIG. 1A.

FIG. 2A is a schematic diagram of a projection device according to another embodiment of the invention.

FIG. 2B is a schematic diagram of a light-emitting device of the projection device shown in FIG. 2A.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “left,” “right,” “front,” “back,” “first direction,” “second direction,” “third direction,” “fourth direction,” “X direction,” “Y direction,” or “Z direction,” etc., is used with reference to the orientation of the Figure(s) being described and are not intended to be limiting of the invention.

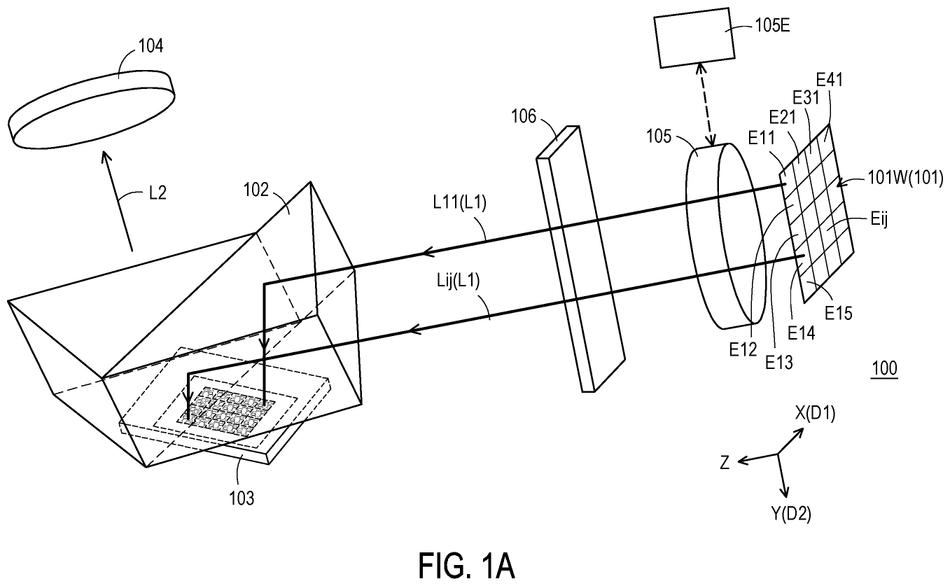

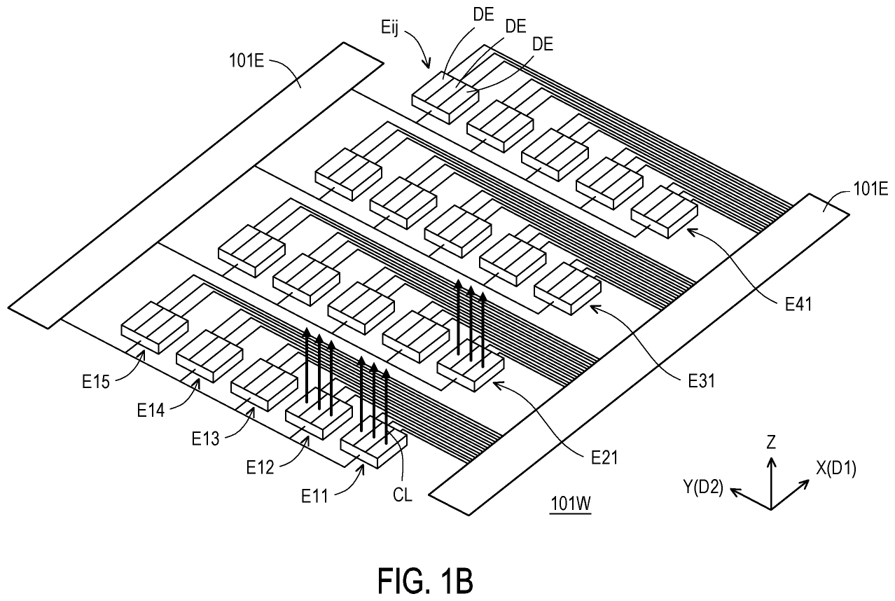

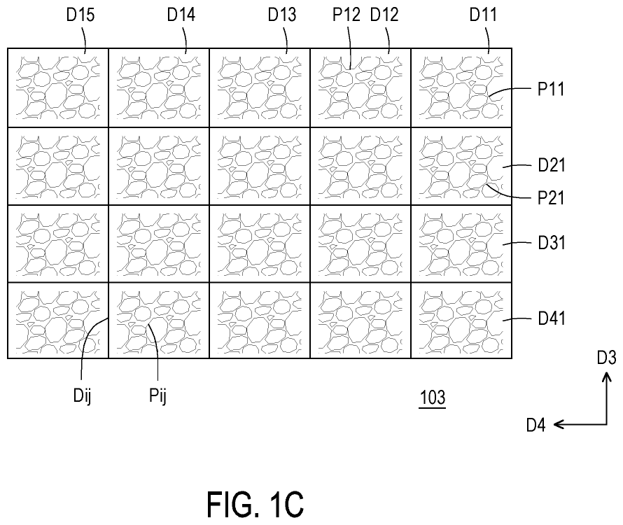

Referring to FIG. 1A to FIG. 1C, FIG. 1A is a schematic diagram of a projection device according to an embodiment of the invention. FIG. 1B is a schematic diagram of a light-emitting device of the projection device shown in FIG. 1A. FIG. 1C is a schematic plan view of a light valve of the projection device shown in FIG. 1A. A projection device 100 includes an illumination system 101, a light valve 103 and a projection lens 104. The illumination system 101 is configured to emit an illumination light beam L1. The light valve 103 is disposed on a transmission path of the illumination light beam L1, and is configured to convert the illumination light beam L1 into an image light beam L2. The projection lens 104 is disposed on a transmission path of the image light beam L2, and is configured to project the image light beam L2 out of the projection device 100 to a projection target (not shown), such as a screen or a wall. A projection device 100 is, for example, a projector.

The illumination system 101 includes a light-emitting device 101W. The light-emitting device 101W is disposed on a reference plane formed by an X direction (or referred to as a first direction D1) and a Y direction (or referred to as a second direction D2). The light-emitting device 101W includes a plurality of light-emitting assemblies Eij. A plurality of light beams Lij emitted by the plurality of light-emitting assemblies Eij move toward in the Z direction. The light beams Lij from the light-emitting device 101W are the illumination light beams L1. Each light-emitting assembly Eij may, for example, include one or a plurality of color light-emitting elements DE (shown in FIG. 1B), and the color light-emitting elements DE may be light-emitting diodes (LEDs), laser diodes (LD) or a combination thereof, or other suitable light sources, which is not limited by the invention.

The light valve 103 is disposed on the transmission path of the illumination light beam L1, and is configured to convert the illumination light beam L1 into the image light beam L2. As shown in FIG. 1C, the light valve 103 is disposed on a reference plane formed by a third direction D3 and a fourth direction D4. The light valve 103 is, for example, a spatial light modulator such as a digital micro-mirror device (DMD), a liquid-crystal-on-silicon panel (LCOS panel), or a liquid crystal panel (LCD), etc. The light valve 103 includes a plurality of light modulation regions Dij. For example, the structure of the light valve 103 may be an array of the plurality of light modulation regions Dij composed of a plurality of micro-mirrors disposed on a wafer, and each light modulation region Dij controls one pixel in an image projected by the projection device 100. The number of the light modulation regions Dij corresponds to a resolution of the projection image. For example, the maximum values of i and j are Max(i, j)=(800, 600), Max(i, j)=(1024, 768), Max(i, j)=(1280, 720) and Max(i, j)=(1920, 1080) etc. In detail, the light valve 103 may rapidly change angles of the micro-lenses of the light valve 103 under control of digital driving signals to select the light modulation regions Dij to be “bright” or “dark”, and determines a brightness of the pixel according to a frequency of switching between “bright” and “dark”.

The projection lens 104 is disposed on the transmission path of the image light beam L2, and is configured to project the image light beam L2 out of the projection device 100. The projection lens 104 is, for example, a combination of one or a plurality of optical lenses having diopters. The optical lenses include, for example, various combinations of non-planar lenses such as a bi-concave lens element, a bi-convex lens element, a concavo-convex lens element, a convexo-concave lens element, a plano-convex lens element, a plano-concave lens element, etc. The invention does not limit a pattern and type of the projection lens 104.

Although FIG. 1A only shows a light beam L11 emitted by the light-emitting assembly E11, in practical applications, each light-emitting assembly Eij may emit the light beam Lij. In the embodiment, the illumination light beam L1 is formed by at least one of the plurality of light beams Lij emitted by the plurality of light-emitting assemblies Eij of the light-emitting device 101W. To be specific, the plurality of light-emitting assemblies Eij may simultaneously emit the plurality of light beams Lij to form the illumination light beams L1, and the illumination light beam(s) L1 may also be formed by at least one of the plurality of light beams Lij in a timing sequence. Therefore, the illumination light beams L1 may form a plurality of light spots Pij on the light valve 103.

Referring to FIG. 1A and FIG. 1C at the same time, the plurality of light modulation regions Dij of the light valve 103 of the embodiment are respectively covered by the light spots Pij of the plurality of light beams Lij. Specifically, the light beam L11 emitted by the light-emitting assembly E11 forms the light spot P11 in the light modulation region D11. Similarly, the light beam L12 (not shown) emitted by the light-emitting assembly E12 forms the light spot P12 in the light modulation region D12, and the light beam L21 (not shown) emitted by the light-emitting assembly E21 forms the light spot P21 in the light modulation region D21, and the others may be deduced by analogy. In general, the light beams Lij emitted by the light-emitting assemblies Eij may form the light spots Pij in the light modulation regions Dij, and the light modulation regions Dij are covered by the light spots Pij. Each light spot Pij is at least partially non-overlapped with another light spot.

Referring to FIG. 1B, the illumination system 101 further includes a local dimming element 101E. Each light emitting assembly Eij is electrically connected to the local dimming element 101E, respectively. Namely, the local dimming element 101E may independently control each light-emitting assembly Eij, for example, control each light-emitting assembly Eij to be turned on or off, control a bright and dark flickering frequency or a light-emitting intensity of the light beams Lij, etc. In other words, through the local dimming element 101E, the plurality of light-emitting assemblies Eij may respectively control optical performances of the plurality of light spots Pij on the plurality of light modulation regions Dij of the light valve 103, i.e., “bright”, “dark”, the bright and dark flickering frequency or the light-emitting intensity.

In other words, since there is a corresponding relationship between the illumination light beams L1 (light beams Lij) emitted by the light-emitting assemblies Eij and the light modulation regions Dij, and the local dimming element 101E may independently control each light-emitting assembly Eij, a purpose of local dimming for the light valve 103 is achieved. In this way the projection device 100 may make a dark state darker and a bright state brighter, thereby improving the contrast ratio of the image projected by the projection device 100.

As shown in FIG. 1B, in the embodiment, the plurality of light-emitting assemblies Eij include light-emitting assemblies E11, E12, E13, E14, E15, E21, E31, E41, where the light-emitting assemblies E11, E12, E13, E14, E15 are arranged in sequence along the second direction D2, and the light-emitting assemblies E11, E21, E31, E41 are arranged in sequence along the first direction D1. The light-emitting assembly E11 and the light-emitting assembly E21 are adjacent in the first direction D1, and the light-emitting assembly E11 and the light-emitting assembly E12 are adjacent in the second direction D2, where the first direction D1 is not parallel to the second direction D2.

In the embodiment, the first direction D1 is perpendicular to the second direction D2, and the plurality of light-emitting assemblies Eij are arranged in a rectangular array, but the invention is not limited thereto. In other embodiments, the first direction D1 may not be perpendicular to the second direction D2, and the plurality of light-emitting assemblies Eij may be arranged in a diamond array.

As shown in FIG. 1C, the plurality of light modulation regions Dij include light modulation regions D11, D12, D13, D14, D15, D21, D31, D41, where the light modulation regions D11, D12, D13, D14, D15 are arranged in sequence along the fourth direction D4, and the light modulation regions D11, D21, D31, D41 are arranged in sequence along a negative direction of the third direction D3. The light modulation region D11 and the light modulation region D21 are adjacent in the third direction D3, and the light modulation region D11 and the light modulation region D12 are adjacent in the fourth direction D4, where the third direction D3 is not parallel to the fourth direction D4.

In the embodiment, the third direction D3 is perpendicular to the fourth direction D4, and the plurality of light modulation regions Dij are arranged in a rectangular array, but the invention is not limited thereto. In other embodiments, the third direction D3 may not be perpendicular to the fourth direction D4, and the plurality of light modulation regions Dij are arranged in a diamond array. In other embodiments, the third direction D3 may be parallel to the first direction D1, and the light valve 103 is disposed on a plane formed by the first direction D1 and the Z direction (shown in FIG. 1A).

Referring to FIG. 1B again, in an embodiment, each light-emitting assembly Eij includes one or more color light-emitting elements DE. The plurality of color light-emitting elements DE may emit a plurality of color light beams CL with different wavelengths, such as a red light beam, a green light beam, a blue light beam, an infrared light beam, an ultraviolet light beam or light beams of other colors. The light beam Lij emitted by each light-emitting assembly Eij includes at least one of the color light beams CL. The plurality of color light-emitting elements DE may include, for example, a red light-emitting element DE that emits the red light beam CL, a green light-emitting element DE that emits the green light beam CL, and a blue light-emitting element DE that emits the blue light beam CL, where the number of the color light-emitting elements DE that emit the red, green and blue light beams CL is not limited, and may be adjusted according to actual design requirements. For example, each light-emitting assembly Eij may have two color light-emitting elements DE that emit the red light beam CL, one color light-emitting element DE that emits the green light beam CL, and one color light-emitting element DE that emits the blue light beam CL. In another embodiment, each light-emitting assembly Eij may have each one of the color light-emitting elements DE that respectively emit red, green and blue light beams CL.

Since each color light-emitting element DE in each light-emitting assembly Eij is independently controlled by the local dimming element 101E (as shown in FIG. 1B), the light-emitting intensity of each color light-emitting element DE may be independently controlled. Therefore, the color and brightness of light emitted by each light-emitting assembly Eij may be controlled by adjusting the light-emitting intensity of each color light-emitting element DE in each light-emitting assembly Eij. Namely, a color and brightness of the light spot Pij on the light modulation region Dij corresponding to each light-emitting assembly Eij may be controlled, i.e., a chromaticity and brightness of each pixel of the image projected by the projection device 100 may be independently controlled.

Referring to FIG. 1A again, in an embodiment, the projection device 100 may further include a light diffusing element 106, which is disposed on the transmission path of the illumination light beam L1 and located between the illumination system 101 and the light valve 103. The light diffusing element 106 may be, for example, a diffusion sheet, an array lens element or a diffuser, but the invention is not limited thereto. After the illumination light beams L1 emitted by the plurality of light-emitting assemblies Eij passes through the light diffusing element 106, among the plurality of light spots Pij formed on the light valve 103, any two adjacent light spots Pij are at least partially overlapped, which achieves an effect of light uniforming, such that the light valve 103 effectively converts the illumination light beam L1 into the image light beam L2.

The projection device 100 may further include at least one lens element 105 disposed on the transmission path of the illumination light beam L1 and located between the illumination system 101 and the light valve 103. In an embodiment, the lens element 105 is located between the light-emitting device 101W of the illumination system 101 and the light diffusing element 106. The illumination light beam L1 sequentially passes through the lens element 105 and the light diffusing element 106 and then illuminates the light valve 103. In an embodiment, the lens element 105 may also be disposed between the light diffusing element 106 and the light valve 103. The lens element 105 may be, for example, a focusing lens. In the embodiment, since only the lens element 105 and the light diffusing element 106 are used to achieve the effect of light spot shaping and uniform illumination, compared with the prior art where a light uniforming element, a wavelength conversion element, a filter element or other optical elements are used in the projection device, the projection device 100 according to the embodiment of the invention does not need to additionally configure the light uniforming element, the wavelength conversion element, the filter element, etc., and uses fewer optical elements, so that the production cost of the projection device 100 is lower. Since the projection device 100 uses fewer optical elements, a light transmittance of the light beam may be higher and an optical attenuation factor may be reduced. In addition, a light etendue of the projection device 100 is small, which is adapted to be used as a high-contrast projection device.

In an embodiment, the projection device 100 may further include at least one actuating element 105E. The actuating element 105E may be, for example, a motor, etc., including a lens element holder, a piezoelectric material, and a mobile lens element holder. The actuating element 105E is connected to the lens element 105. The lens element 105 may be disposed directly or indirectly on the actuating element 105E. The actuating element 105E is configured to move a position of the lens element 105 or change an inclination angle of the lens element 105 relative to the light-emitting device 101W. When the inclination angle of the lens element 105 relative to the light-emitting device 101W is changed, positions of the plurality of light spots Pij relative to the plurality of light modulation regions Dij are changed, for example, the plurality of light spots Pij move along the third direction D3 and/or along the fourth direction D4. In addition, when a position of the lens element 105 in the Z direction is changed, sizes of the plurality of light spots Pij on the plurality of light modulation regions Dij are changed, so as to achieve the best image quality output. In the embodiment, since the projection device 100 may have the effect of adjusting the positions and sizes of the plurality of light spots Pij based on the adjustability of the lens element 105, a mechanism assembly tolerance of the projection device 100 may be reduced.

In an embodiment, the projection device 100 may further include a light redirecting element 102. The light redirecting element 102 may be, for example, a TIR mirror or a combination of a mirror and a lens element, where the TIR mirror may be formed by gluing two prisms. The light redirecting element 102 is disposed between the light valve 103 and one of the illumination system 101, the lens element 105 and the light diffusing element 106. The light redirecting element 102 is configured to change a transmission direction of the illumination light beam L1, so that the illumination light beam L1 may be transmitted to the light valve 103, and the image light beam L2 from the light valve 103 may be transmitted to the projection lens 104. In other embodiments, the projection device 100 may not include the light redirecting element 102, and the illumination light beam L1 emitted by the illumination system 101 may illuminate the light valve 103 without being redirected.

In order to fully illustrate the various implementations of the invention, other embodiments of the invention will be described below. It should be noticed that reference numbers of the components and a part of contents of the aforementioned embodiment are also used in the following embodiment, where the same reference numbers denote the same or like components, and descriptions of the same technical contents are omitted. The aforementioned embodiment may be referred for descriptions of the omitted parts, and detailed descriptions thereof are not repeated in the following embodiment.

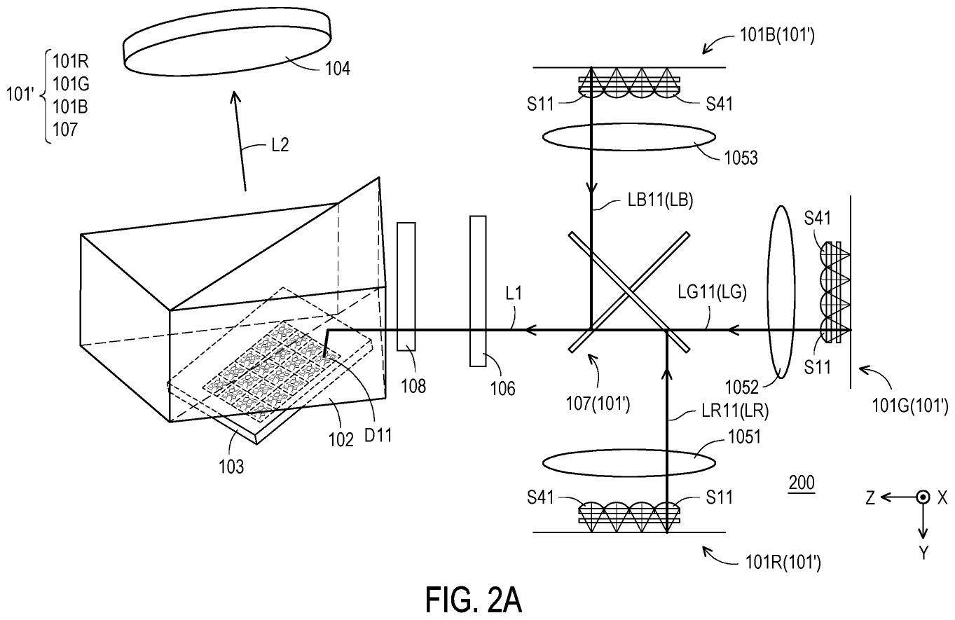

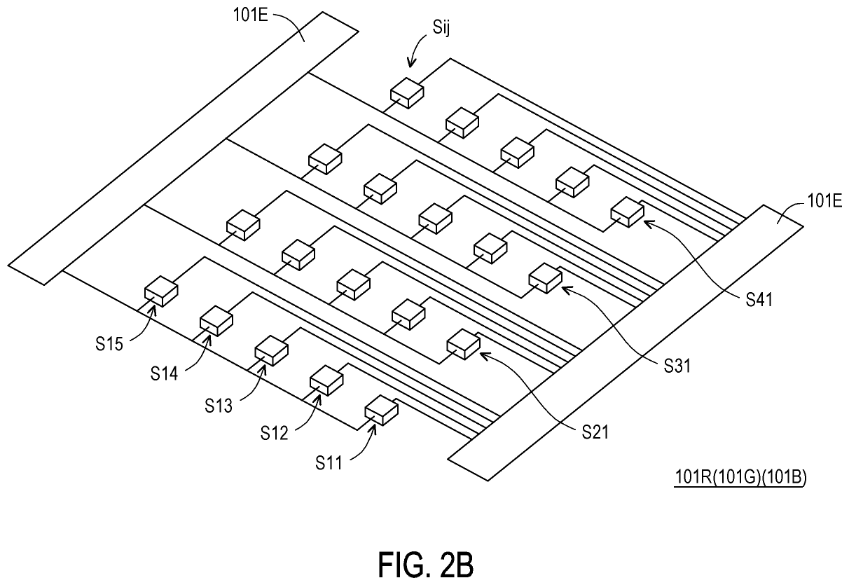

Referring to FIGS. 2A and 2B, FIG. 2A is a schematic diagram of a projection device according to another embodiment of the invention. FIG. 2B is a schematic diagram of a light-emitting device of the projection device shown in FIG. 2A. A difference between a projection device 200 and the projection device 100 in FIG. 1A is that an illumination system 101′ of the projection device 200 includes a plurality of light-emitting devices 101R, 101G, 101B, which are respectively configured to emit a first color light beam, a second color light beam and a third color light beam, where color of the first color light beam, the second color light beam and the third color light beam are different from each other. In the embodiment, the first color light beam, the second color light beam and the third color light beam are, for example, respectively a red light beam LR, a green light beam LG, and a blue light beam LB, but the invention is not limited thereto.

Each of the light-emitting device 101R, the light-emitting device 101G, and the light-emitting device 101B has a plurality of light-emitting assemblies Sij. The plurality of light-emitting assemblies Sij are configured to illuminate the plurality of light modulation regions Dij of the light valve 103. For the convenience of clear description, FIG. 2A only shows a situation that a red light beam LR11 emitted by the light-emitting assembly S11 of the light-emitting device 101R, a green light beam LG11 emitted by the light-emitting assembly S11 of the light-emitting device 101G, and a blue light beam LB 11 emitted by the light-emitting assembly S11 of the light-emitting device 101B illuminate the light modulation region D11 of the light valve 103.

In the embodiment, the illumination system 101′ further includes a light guide element 107, the light guide element 107 is configured to guide a plurality of color light beams to the light valve 103, and the light beams from the light guide element 107 are the illumination light beams L1. More specifically, the light guide element 107 is disposed on a transmission path of the red light beam LR, the green light beam LG, and the blue light beam LB, and is located between the light-emitting devices 101R, 101B, 101G and the light diffusing element 106. The light guide element 107 may be, for example, a mirror or an element having a reflective region or a light-transmitting region. For example, the red light beam LR emitted by the light-emitting device 101R is reflected by the light guide element 107 to enter the light diffusing element 106, the blue light beam LB emitted by the light-emitting device 101B is reflected by the light guide element 107 to enter the light diffusing element 106, and the green light beam LG emitted by the light-emitting device 101G passes through the light guide element 107 to enter the light diffusing element 106. The red light beams LRij emitted by the light-emitting assemblies Sij of the light-emitting device 101R, the green light beams LGij emitted by the light-emitting assemblies Sij of the light-emitting device 101G, and the blue light beams LBij emitted by the light-emitting assemblies Sij of the light-emitting device 101B may simultaneously or sequentially illuminate the light modulation regions Dij of the light valve 103. The light spots Pij covering the light modulation regions Dij include at least one of a red light spot, a green light spot and a blue light spot.

Each light-emitting assembly Sij on each of the light-emitting devices 101R, 101G, 101B is independently controlled by the local dimming element 101E (as shown in FIG. 2B), and light-emitting intensity of each light-emitting assembly Sij on each of the light-emitting devices 101R, 101G, 101B may be independently controlled. Therefore, the projection device 200 of the embodiment may control a color and intensity of the light spot Pij on the light modulation region Dij corresponding to each light-emitting assembly Sij on each of the light-emitting devices 101R, 101G, 101B, i.e., the chromaticity and brightness of each pixel of the image projected by the projection device 200 may be independently controlled.

The projection device 200 may further include lens elements 1051, 1052 and 1053, respectively corresponding to the light-emitting devices 101R, 101G, 101B. Similar to the lens element 105 in FIG. 1A, by adjusting the at least one actuating element (for example, the actuating element 105E shown in FIG. 1A) to change inclination angles of the lens elements 1051, 1052, 1053 relative to the light-emitting devices 101R, 101G, 101B, positions of the red light spot, the green light spot and the blue light spot of the plurality of light spots Pij with respect to the plurality of light modulation regions Dij are changed. By adjusting the at least one actuating element to change distances of the lens elements 1051, 1052, 1053 relative to the light-emitting devices 101R, 101G, 101B, sizes of the red light spot, the green light spot, and the blue light spot in the plurality of light spots Pij are changed on the plurality of light modulation regions Dij. By adjusting the lens elements 1051, 1052, and 1053, an optimized output of the projection device 200 may be obtained.

The projection device 200 may further include an optical functional element 108 disposed between the light diffusing element 106 and the light valve 103. The optical functional element 108 may be at least one of a depolarizer and a despeckling element to avoid speckle. The optical functional element 108 is configured to adjust the light beam, for example, the depolarizer is configured to depolarize the illumination light beam L1, and the despeckling element is configured to despecke the illumination light beam L1. The despeckling element is, for example, a scattering plate or an optical element vibration device, etc.

In summary, the projection device provided by the embodiment of the invention respectively illuminates the plurality of light modulation regions of the light valve with a plurality of illumination light beams emitted by a plurality of light-emitting assemblies. The plurality of light-emitting assemblies may respectively control optical performances of the plurality of light spots on the plurality of light modulation regions, thus achieving the purpose of local dimming for the light valve, thereby improving a contrast ratio of the image projected by the projection device.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection device, comprising:
an illumination system, configured to emit an illumination light beam, and comprising at least one light-emitting device, wherein the at least one light-emitting device comprises a plurality of light-emitting assemblies;
a light valve, disposed on a transmission path of the illumination light beam and configured to convert the illumination light beam into an image light beam, wherein the light valve comprises a plurality of light modulation regions; and
a projection lens, disposed on a transmission path of the image light beam, and configured to project the image light beam out of the projection device,
wherein the plurality of light-emitting assemblies of the at least one light-emitting device emit the illumination light beams, and the illumination light beams form a plurality of light spots on the light valve, and the plurality of light modulation regions are respectively covered by the plurality of light spots.

2. The projection device according to claim 1, wherein the plurality of light-emitting assemblies comprise a first light-emitting assembly, a second light-emitting assembly, and a third light-emitting assembly, wherein the first light-emitting assembly and the second light-emitting assembly are adjacent in a first direction, the first light-emitting assembly and the third light-emitting assembly are adjacent in a second direction, and the first direction is not parallel to the second direction, and wherein the plurality of light modulation regions comprise a first light modulation region, a second light modulation region, and a third light modulation region, wherein the first light modulation region and the second light modulation region are adjacent in a third direction, the first light modulation region and the third light modulation region are adjacent in a fourth direction, and the third direction is not parallel to the fourth direction.

3. The projection device according to claim 2, wherein the first direction is perpendicular to the second direction.

4. The projection device according to claim 2, wherein the third direction is perpendicular to the fourth direction.

5. The projection device according to claim 2, wherein the plurality of light spots comprise a first light spot, a second light spot, and a third light spot, the illumination light beams emitted by the first light-emitting assembly, the second light-emitting assembly, and the third light-emitting assembly respectively form the first light spot, the second light spot, and the third light spot on the light valve, and the first light modulation region, the second light modulation region, and the third light modulation region are respectively covered by the first light spot, the second light spot, and the third light spot.

6. The projection device according to claim 5, wherein the first light spot and the second light spot are at least partially non-overlapped, and the first light spot and the third light spot are at least partially non-overlapped.

7. The projection device according to claim 1, wherein a number of the at least one light-emitting device is multiple, and the plurality of light-emitting devices comprise a first light-emitting device, a second light-emitting device, and a third light-emitting device respectively configured to emit a first color light beam, a second color light beam, and a third color light beam.

8. The projection device according to claim 7, wherein the illumination system further comprises a light guide element configured to guide the first color light beam, the second color light beam, and the third color light beam to the light valve.

9. The projection device according to claim 7, wherein each of the first light-emitting device, the second light-emitting device, and the third light-emitting device comprises the plurality of light-emitting assemblies illuminating the plurality of light modulation regions.

10. The projection device according to claim 1, wherein each of the plurality of light-emitting assemblies comprises a plurality of color light-emitting elements, and the plurality of color light-emitting elements are configured to emit a plurality of color light beams.

11. The projection device according to claim 1, wherein the illumination system further comprises a local dimming element electrically connected to each of the plurality of light-emitting assemblies and configured to control a light-emitting intensity of each of the light-emitting assemblies.

12. The projection device according to claim 1, further comprising a light diffusing element disposed on the transmission path of the illumination light beam and located between the illumination system and the light valve, wherein after the illumination light beams emitted by the plurality of light-emitting assemblies pass through the light diffusing element, the illumination light beams form the plurality of light spots on the light valve, the plurality of light modulation regions are respectively covered by the plurality of light spots, and the plurality of light spots are at least partially overlapped with each other.

13. The projection device according to claim 12, further comprising at least one of a depolarizer and a despeckling element disposed on the transmission path of the illumination light beam and located between the light diffusing element and the light valve.

14. The projection device according to claim 1, further comprising at least one lens element disposed on the transmission path of the illumination light beam and located between the illumination system and the light valve.

15. The projection device according to claim 14, further comprising at least one actuating element, wherein the at least one lens element is disposed on the at least one actuating element, the at least one actuating element is configured to move a position of the at least one lens element or change an inclination angle of the at least one lens element relative to the at least one light-emitting device, and positions and sizes of the plurality of light spots relative to the plurality of light modulation regions change along with the inclination angle and movement of the at least one lens element.
